(19) United States
(12) Patent Application Publication
(10) Pub. No.: US 2018/0268681 A1
(43) Pub. Date: Sep. 20, 2018

(54) METHOD AND SYSTEM FOR GENERATING AND TRANSMITTING AN EMERGENCY CALL SIGNAL

(71) Applicant: DIGADES GMBH, Zittau (DE)

(72) Inventors: Manius SCHINKEL, Lipprechterode (DE); Christoph SCHWENK, Demitz-Thumitz (DE); Christian SCHMUCKING, Nordhausen (DE)

(73) Assignee: DIGADES GMBH, Zittau (DE)

(21) Appl. No.: 15/762,305

(22) PCT Filed: Sep. 20, 2016
(86) PCT No.: PCT/EP2016/072280

§ 371 Date: Mar. 22, 2018

(30) Foreign Application Priority Data
Sep. 22, 2015 (DE) 10 2015 218 170.7

(51) Int. Cl. G08B 25/01; G08B 25/00; H04M 3/51; H04W 4/029; H04W 4/44; H04W 4/80; H04W 4/90; G10L 13/04

(52) U.S. Cl. CPC G08B 25/016; G08B 25/001; H04M 3/5116; H04W 4/029; H04M 2242/30; H04W 4/80; H04W 4/90; G10L 13/043; H04M 2242/04; H04W 4/44

(57) ABSTRACT

The present invention relates to a method and a system for generating and transmitting an emergency call signal. In this case, in the event of a dangerous situation involving a road vehicle, an emergency call signal having a minimum set of data (MSD) is independently generated in coded form by a base module (1) arranged on the road vehicle and is transmitted by means of a first telecommunications connection (3a, 3b) to a central switching unit (2). The emergency call signal is then decoded by the central switching unit (2) and a text file is generated, from this information and further information stored in the central switching unit, in a language which is conventional in an area defined by the position information. This language-dependent text file is converted into an audio file, and the audio file is transmitted to the base module (1) via the first telecommunications connection (3a, 3b), and an emergency call center (6) is then contacted by the base module (1) by establishing a second telecommunications connection (4), and the audio file is played at least once, or a further telecommunications connection to the emergency call center (6) is established by the central switching unit, via which the audio file is transmitted and is played at least once in the emergency call center (6).

The present invention relates to a method and a system for generating and transmitting an emergency call signal.

On account of increased safety requirements, independently acting safety systems are increasingly required in automobiles. In this context, a pan-European electronic emergency call system, also known as “e-call” system, will be installed by 2018, in which a telecommunications connection to an emergency call center is automatically set up in the event of an accident, with the result that a driver of the vehicle can communicate with the emergency call center.

The disadvantage of this solution is that the system reaches its limits when, after the accident, none of the vehicle occupants is able to speak to the emergency call center, for example on account of a loss of consciousness, or when none of the vehicle occupants is proficient in the language of the employee of the emergency call center. The data in the “MSD” (Minimum Set of Data) transmitted during the emergency call contain only the data relating to the vehicle and its position which are anchored as a minimum in the standard.

The present invention is therefore based on the object of developing a method and a system which avoids the disadvantages mentioned, that is to say which can be used to transmit information relating to the vehicle and the driver to an emergency call center irrespective of the language.

This object is achieved, according to the invention, by means of a method according to claim 1 and a system according to claim 11. Advantageous configurations and developments are described in the dependent claims.

A method for generating and transmitting an emergency call signal is introduced, in which, in the event of a dangerous situation involving a road vehicle, typically an automobile, a truck, a motorcycle or an all-terrain vehicle, an emergency call signal having a minimum set of data (MSD) is generated by a base module arranged on the road vehicle. The minimum set of data contains at least one item of identity information relating to the respective base module, for example a serial number, and an item of position information relating to the base module which is determined by means of satellite-based navigation or by identifying the radio cell in which the road vehicle is situated (for example the cell ID of the mobile radio base station).

The emergency call signal is transmitted by establishing a first telecommunications connection to a central switching unit by means of predetermined connection information stored in the base module. The emergency call signal is then decoded with respect to the coded information contained therein by the central switching unit, and a text file is generated, with the aid of this information and the further information relating to a user, for example a driver, stored under certain circumstances in the central switching unit, in a language which is conventional in an area defined by the position information, preferably an official language of the area in which the road vehicle, together with the base module, is currently situated. The language-dependent text file is converted into an audio file by means of the data stored in a storage unit of the central switching unit. An emergency call center, which can also be referred to as a rescue coordination center, is then contacted by the base module by setting up a conference call, and the audio file is played at least once by the central switching unit as spoken information.

Alternatively, after the audio file has been created, the central switching unit can also directly set up a further telecommunications connection to an emergency call center, via which the audio file is transmitted to the emergency call center and is played there at least once. This sequence is based on pure voice connections via the mobile radio network and fixed network, but requires the support of conference calls in a mobile radio network used for telecommunications.

A further alternative sequence which does not require a conference call provides for the minimum set of data (MSD) for each data channel in the mobile radio network to be transmitted to the central switching unit, for the latter to transmit the generated voice file for each data channel to the base module and for the connection to the central switching unit to then be terminated. The base module then sets up a second voice connection to the emergency call center and plays the voice file generated by the central switching unit.

The set of data transmitted as the emergency call signal is formatted according to the e-call standard and comprises at least the minimum set of data (MSD).

In the absence of the first telecommunications connection to the central switching unit, the base module can independently establish a telecommunications connection to an emergency call center and can both transmit the minimum set of data (MSD) and support a voice connection. A voice connection can be supported by setting up and maintaining a radio connection or a telephone connection.

At the start of the voice connection to the emergency call center, the base module can transmit the minimum set of data (MSD) in accordance with the pan-European e-call standard, followed by the variant which is “read aloud”.

As a result of the fact that the emergency call signal contains at least information which can be used to uniquely identify the road vehicle affected by a dangerous situation, such as an accident, on the basis of the base module permanently mounted on the road vehicle and makes it possible to accurately determine the position, all essential information is present in order to notify the emergency call center of the dangerous situation. The emergency call signal can be independently transmitted by virtue of the connection information being stored in the base module.

The transmission of the minimum set of data (MSD) in coded form is used, on the one hand, for anonymized transmission but, on the other hand, can also keep the volume of data to be transmitted low using packed data. Converting the information from the emergency call signal into an audio file held in a language which is spoken in the area defined by the position information makes it possible for the emergency call center to always evaluate the transmitted information relating to the dangerous situation. Since the emergency call signal is processed and language-dependent text and audio files are produced only in the central switching unit and not already in the base module, new languages, further information or updates can be maintained more easily, on the one hand, since the affected vehicle does not have to be updated in a workshop and less storage space is required in the base module, on the other hand, with the result that the base module can have a more compact and cost-effective structure. In this case, the dispensing with a DSP (digital signal processor) for producing the speech in the different languages, the dispensing with larger controllers and the dispensing with larger memories should be emphasized, in particular. With regard to the software, a more compact software architecture can be pointed out.

Transmission of data may fail because of the availability of the necessary in-band transmission technology according to the pan-European e-call in the PSAP (rescue coordination centers). In the pan-European e-call, e-call-relevant data, such as position, vehicle class, VIN etc., are transmitted using the in-band method, that is to say within the voice frequency band, as a minimum set of data as part of the pan-European e-call. A remote station which can decrypt these data has the possibility of identifying the relevant data and reacting accordingly. A modern remote station without the possibility of decoding in-band data would not receive any indications; in this case, in the present invention, position, vehicle class etc. are indicated by voice by reading aloud the automatically generated file containing the relevant information. In countries where in-band communication is not supported (for example outside the EU), this likewise provides the advantage that the person receiving the emergency call receives an emergency call announcement in his national language and receives an announcement of the relevant data (position, vehicle class etc.). The announcement can be repeated. The present emergency call system can therefore be operated completely independently of the pan-European e-call standard, but remains compatible.

Provision may also be made for the first telecommunications connection, the second telecommunications connection and/or the further telecommunications connection to be a radio connection or a telephone connection. At least one of the telecommunications connections is typically in the form of an Internet telephony connection which is also referred to as a “Voice-over-Internet-Protocol” (VoIP) connection.

The central switching unit can transmit a stop signal to the base module as soon as the text file has been generated in the central switching unit, with the result that the transmission of the emergency call signal is terminated by the base module. This helps to avoid unnecessary transfer of information, especially since telecommunications channels are often overloaded, for example in the case of mass crashes in which a multiplicity of such emergency call signals are transmitted at the same time. A plurality of emergency calls from the same accident or accident area can be detected only by a central contact point, such as a central switching unit.

The decoded information from the emergency call signal can be forwarded from the central switching unit to an external storage unit and can be archived there. After the dangerous situation, this can be used for evidentiary or documentation purposes, for example.

The central switching unit can also notify further parties which can be preconfigured in the central switching unit, for example by the driver or another user of the vehicle. The system could be additionally used to capture traffic and accident data and to make them available to interested private and public organizations after suitable evaluation.

The user of the road vehicle, typically the driver, can have a voice connection to the base module via a wireless radio connection, preferably via a wireless radio connection according to the industrial standard IEEE 802.15.1, which is also known as Bluetooth. This makes it possible for the user to also communicate with the emergency call center and to forward information relating to his own condition or further persons affected by the dangerous situation or the accident. A conference call is preferably set up between the base module, the emergency call center and the central switching unit for this purpose, during which call the user can directly contact the emergency call center.

In a particularly preferred manner, the audio file can be automatically played to the emergency call center several times after the second telecommunications connection has been established in order to also transmit information which was possibly not understood when played for the first time. Renewed playback can also be initiated by the emergency call center. In addition, the audio file can also be played to the emergency call center in a constantly repeated manner until the emergency call center or the driver stops this playback by means of voice or by means of a signal transmitted in another manner. This can be achieved by disconnecting the connection, for example.

Provision may also be made for the establishment of the first telecommunications connection to be indicated to the user of the vehicle by the base module, for example by means of a voice message or an optical signal, and for the user to be able to terminate the transmission of the emergency call signal in order to avoid initiation of an unnecessary rescue operation in the event of a false alarm.

In this case, the position information can be obtained from a satellite-based position detection system, for example the Global Positioning System (GPS), Glonass, Beidou or Galileo. This allows a position to be determined with a very high degree of accuracy. In this case, the base module has a receiving unit tuned to the respective system. Alternatively, the cell ID of the mobile radio base station can be used by the central switching unit to roughly determine the position. However, this may result in very great vagueness and may result in the emergency call center not sending any help.

A system for generating and transmitting an emergency call signal has a base module and a central switching unit. The base module is arranged on a road vehicle and is set up, in the event of a dangerous situation involving the road vehicle, to independently generate an emergency call signal having a minimum set of data in coded form, said set of data containing at least one item of identity information relating to the respective base module and an item of position information relating to the base module which is determined by means of satellite-based navigation, and to transmit said emergency call signal by establishing a first telecommunications connection to a central switching unit by means of predetermined connection information stored in the base module.

The central switching unit is set up to then decode the emergency call signal with respect to the information contained therein and to generate a text file, from the position information by means of the central switching unit, in a language which is usually spoken in an area defined by the position information and to convert this language-dependent text file into an audio file by means of data stored in a storage unit of the central switching unit.

The central switching unit is also designed to transmit the audio file to the base module via the first telecommunications connection. The base module is also designed to then contact an emergency call center by establishing a second telecommunications connection and to play the audio file.

In one alternative, the central switching unit is designed to set up a further telecommunications connection to an emergency call center and to transmit the audio file via the further telecommunications connection and to play it in the emergency call center.

In another alternative, the base module can be designed to contact an emergency call center by establishing a further telecommunications connection in the form of a conference call, and the central switching unit can be simultaneously designed to play the audio file in the conference call.

The base module can also be designed to independently establish a telecommunications connection to an emergency call center in the absence of the first telecommunications connection to the central switching unit and to both transmit the minimum set of data (MSD) and support a voice connection.

The central switching unit is preferably a server which has a text-to-speech unit for converting the text file into the audio file.

The central switching unit can be additionally used as a database in order to optionally store sensitive data relating to the driver and to forward said data in an emergency. Said data may be health information, for example blood group, allergies and illnesses, or contacts to be notified in an emergency.

In a further expansion phase of the system, the central switching unit may store data which can also be collected by the base module during normal operation, that is to say during operation without an accident. Said data may be, for example, position data or data relating to the driving behavior. Position data may be used, for example, to locate a stolen vehicle. Said data may be retrieved via an app or by telephone by means of a voice announcement.

Alternatively or additionally, exactly one single item of region-specific emergency call information in the form of an emergency call number to be dialed, for example the emergency call number “112”, can be stored in the base module, with the result that no storage space is required for further emergency call numbers which are not required anyway in particular regions, for example Europe.

The system described is typically set up to carry out the method described or the method described can be carried out using the system described.

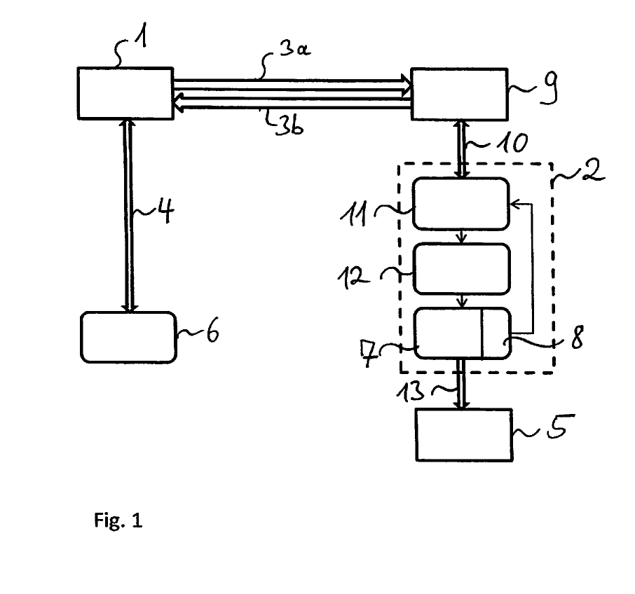

One exemplary embodiment of the invention is illustrated in the drawing and is explained below on the basis of FIG. 1.

The example of a system according to the invention comprises:

1) a base module 1 which is installed in a vehicle,

2) a central switching unit 2 comprising
a) an extension 11 for receiving calls,
b) an in-band communication server 12 which evaluates the received signal,
c) a text-to-speech unit 7 which converts the evaluated signal into speech, and
d) a storage unit 8 which stores the resulting voice file.

An SIP provider 9 (Session Initiation Protocol) and an emergency call center 6 for receiving emergency calls participate.

FIG. 1 shows a schematic diagram depicting communication paths between individual units of a system for generating and transmitting an emergency call signal. In the event of an accident, the base module 1 transmits an emergency call signal having a minimum set of data (MSD) to the central switching unit 2 via the mobile radio network and the SIP provider 9 (Session Initiation Protocol) by means of a first telecommunications connection 3a, said set of data comprising at least one identification number of the base module 1 affected by the accident and a position of said base module. The base module 1 is arranged on the vehicle and has a receiver for a satellite-based navigation system which can be used to determine the position. Provision is also made of a transmitting unit which can contact the central switching unit 2 via the mobile radio network and the SIP provider 9. Said transmitting unit transmits the emergency call signal in coded form, which is intended to be understood as meaning, in particular, an encrypted signal and/or a modulated or packed signal.

In the exemplary embodiment illustrated, the emergency call signal is forwarded via a first telecommunications connection 3a, a VoIP connection in the exemplary embodiment illustrated, by initiating a connection 10 to the in-band communication server 12 as the central switching unit 2 and is processed further in the in-band communication server as the central switching unit 2. In further exemplary embodiments, the SIP provider 9 may also be part of the in-band communication server as the central switching unit 2.

The extension 11 in the in-band communication server as the central switching unit 2, an Asterisk PBX (Private Branch Exchange), for example, in the exemplary embodiment illustrated, receives the emergency call signal and transmits it to the in-band server 12 which decodes the emergency call signal. After decoding, the in-band server 12 generates a language-dependent text file. In the exemplary embodiment illustrated, the language of the file depends on an official language of the country or region in which the vehicle is currently situated according to the position information. For this purpose, a plurality of corresponding language-dependent text files are stored in a memory of the in-band communication server as the central switching unit 2.

The language-dependent text file is transferred to a text-to-speech unit 7 which likewise has an internal storage unit 8. The text-to-speech unit (TTS) 7 converts the language-dependent text file into an audio file in the same language, for which purpose it resorts to stored language expressions which are stored in the internal storage unit 8. The text-to-speech unit 7 forwards the audio file to the extension 11. The text-to-speech unit 7 also transmits a stop signal via the extension 11 in order to prevent further transmission of the emergency call signal. At the same time, in the exemplary embodiment illustrated, the information contained in the original emergency call signal and the generated text file and the generated audio file are transmitted to an external storage unit 5 via a communication channel 13 independently of preceding steps and are stored there for evidence preservation purposes.

The extension 11, the in-band server 12 and the text-to-speech unit 7 may be combined in a single server or may be in the form of separate servers.

The extension 11 transmits the audio file to the base module 1 via the SIP provider 9 and the first telecommunications connection 3b which, for reasons of clarity, is held in two arrows with different reference signs in FIG. 1. This is typically effected in the form of a call which is received by the base module 1 and the base module sets up a conference call between an emergency call center 6, an occupant of the vehicle involved in the accident and the in-band communication server 2 via a second telecommunications connection 4.

Alternatively, the telephone connection to the central switching unit 2 can be maintained and the second telephone connection to the emergency call center 6 can be established as a conference call by the base module 1.

The audio file transmitted by the central switching unit 2 is played at least twice to the emergency call center 6, also referred to as a “public answering safety point, PSAP”, and the emergency call center can then attempt to speak to one of the vehicle occupants, typically a driver of the vehicle, via the second communication connection 4 in order to obtain further information relating to the accident. In the exemplary embodiment illustrated, the corresponding vehicle occupant is here a participant in the conference call via a Bluetooth connection.

If a response from the emergency call center 6 or the central switching unit 2 does not reach the base module 1 for unforeseeable reasons, the base module 1 can independently set up a connection to the emergency call center 6 after the expiry of a predefinable time and can attempt to transmit the data in-band and to establish the voice connection.

In order to avoid false alarms, provision may also be made for an optical signal, such as a flashing LED, to indicate the transmission of the emergency call signal to the vehicle operators and for the transmission of the emergency call signal to be able to be prevented by one of the drivers by pressing a particular button.

The conference call is finally terminated either by the emergency call center 6 or the base module 1, for example in a manner initiated by one of the vehicle occupants.

1. A method for generating and transmitting an emergency call signal, in which,
in the event of a dangerous situation involving a road vehicle, an emergency call signal having a minimum set of data (MSD) is independently generated in coded form by a base module (1) arranged on the road vehicle, said set of data containing at least one item of identity information relating to the respective base module (1) and an item of position information relating to the base module (1) which is determined by means of satellite-based navigation or by identifying the radio cell in which the road vehicle is situated, and
is transmitted by establishing a first telecommunications connection (3a, 3b) to a central switching unit (2) by means of predetermined connection information stored in the base module (1), wherein
the emergency call signal is then decoded with respect to the information contained therein by the central switching unit (2), and
a text file is generated, from the position information by the central switching unit (2), in a language which is conventional in an area defined by the position information, wherein
this language-dependent text file is converted into an audio file by means of data stored in a storage unit (8) of the central switching unit (2), and
the audio file is transmitted to the base module (1) via the first telecommunications connection (3a, 3b), and an emergency call center (6) is then contacted by the base module (1) by establishing a second telecommunications connection (4) or by establishing a further telecommunications connection directly from the central switching unit (2), and the audio file is played at least once, or
a conference call is set up between the base module (1), the emergency call center (6) and the central switching unit (2) by the base module (1) and the audio file is then played at least once.

2. The method as claimed in claim 1, characterized in that the first telecommunications connection (3a, 3b), the second telecommunications connection (4) and/or the further telecommunications connection is/are in the form of a radio connection or a telephone connection.

3. The method as claimed in claim 2, characterized in that the first telecommunications connection (3a, 3b), the second telecommunications connection (4) and/or the further telecommunications connection is/are in the form of an Internet telephony connection.

4. The method as claimed in claim 1, characterized in that the central switching unit (2) transmits a stop signal to the base module (1) as soon as the text file has been generated in the central switching unit (2), with the result that the transmission of the emergency call signal is terminated by the base module (1).

5. The method as claimed in claim 1, characterized in that the decoded information from the emergency call signal is forwarded from the central switching unit (2) to an external storage unit (5) and is archived there.

6. The method as claimed in claim 1, characterized in that a user of the road vehicle has a voice connection to the base module (1) via a wireless radio connection, preferably via a wireless radio connection according to the industrial standard IEEE 802.15.1.

7. The method as claimed in claim 1, characterized in that the establishment of the first telecommunications connection (3a, 3b) is indicated to the user of the vehicle by the base module and the user can terminate the transmission of the emergency call signal.

8. The method as claimed in claim 1, characterized in that, at the start of the voice connection to the emergency call center (6), the minimum set of data (MSD) is transmitted in accordance with the e-call standard and the audio file is then played.

9. The method as claimed in claim 1, characterized in that the audio file is played to the emergency call center (6) in a constantly repeated manner until the emergency call center or the user stops the playback by means of voice or by means of a signal transmitted in another manner.

10. The method as claimed in claim 1, characterized in that further parties preconfigured in the central switching unit (2) are informed by the central switching unit (2).

11. A system for generating and transmitting an emergency call signal, in which
a base module (1) is arranged on a road vehicle and is set up, in the event of a dangerous situation involving the road vehicle, to independently generate an emergency call signal having a minimum set of data (MSD) in coded form, said set of data containing at least one item of identity information relating to the respective base module (1) and an item of position information relating to the base module (1) which is determined by means of satellite-based navigation, and
to transmit said emergency call signal by establishing a first telecommunications connection (3a, 3b) to a central switching unit (2) by means of predetermined connection information stored in the base module (1), wherein
the central switching unit (2) is set up to then decode the emergency call signal with respect to the information contained therein and
to generate a text file, from the position information by means of the central switching unit (2), in a language which is usually spoken in an area defined by the position information and
to convert this language-dependent text file into an audio file by means of data stored in a storage unit (8) of the central switching unit (2) and
to transmit the audio file to the base module (1) via the first telecommunications connection (3a, 3b), wherein the base module (1) is then designed to contact an emergency call center (6) by establishing a second telecommunications connection (4) and to play the audio file, or
the central switching unit (2) is additionally set up to set up a further telecommunications connection to an emergency call center (6) and to transmit the audio file via the further telecommunications connection and to play it in the emergency call center (6), or
the base module (1) is designed to contact an emergency call center (6) by establishing a second telecommunications connection (4) in the form of a conference call, and audio file is played by the central switching unit (2).

12. The system as claimed in claim 11, characterized in that the base module (1) is designed to independently establish a telecommunications connection (4) to an emergency call center (6) in the absence of the first telecommunications connection (3a) to the central switching unit (2) and to both transmit the minimum set of data (MSD) and support a voice connection.

13. The system as claimed in claim 11, characterized in that the central switching unit (2) is a server which has a text-to-speech unit (7) for converting the text file into the audio file.

14. The system as claimed in claim 11, characterized in that exactly one single item of region-specific emergency call information in the form of an emergency call number to be dialed is stored in the base module (1).

15. The system as claimed in claim 11, characterized in that the central switching unit (2) is designed, as a database, to store sensitive data relating to the driver, in particular health information, illnesses and/or contacts to be informed in an emergency, and to forward said data in an emergency.

16. The system as claimed in claim 11, characterized in that the central switching unit (2) is designed to store data collected by the base module (1) during normal operation, in particular position data and/or data relating to the driving behavior.
